(19) United States
(12) Patent Application Publication
(10) Pub. No.: US 2017/0249836 A1
(43) Pub. Date: Aug. 31, 2017

(54) Conflict-Resolution System For Operating An Automated Vehicle

(71) Applicant: Delphi Technologies, Inc., Troy, MI (US)

(72) Inventors: Michael H. Laur, Mission Viejo, CA (US); John P. Absmeier, Capitola, CA (US); Nandita Mangal, Palo Alto, CA (US); Wu Dun, Sunnyvale, CA (US); Divya Agawal, Sunnyvale, CA (US); Junqing Wei, Bridgeville, PA (US)

(21) Appl. No.: 15/053,414

(22) Filed: Feb. 25, 2016

(51) Int. Cl. G08G 1/01; G05D 1/00

(52) U.S. Cl. CPC G08G 1/0137; G05D 1/0088

(57) ABSTRACT

A conflict-resolution system for operating an automated vehicle includes an intersection detector, a vehicle-detection device, and a controller. The intersection detector is suitable to mount on a host-vehicle. The detector used to determine when the host-vehicle is stopped at or approaches an intersection. The vehicle-detection device is suitable to mount on the host-vehicle. The device is used to detect when an other-vehicle has stopped at or approaches the intersection at the same instant as the host-vehicle. The controller is in communication with the detector and the device. The controller is configured to determine a wait-time for the host-vehicle to wait before attempting to proceed into the intersection when right-of-way rules are unable to determine when the host-vehicle should proceed into the intersection.

### TECHNICAL FIELD OF INVENTION

This disclosure generally relates to a conflict-resolution system for operating an automated vehicle, and more particularly relates to determining a wait-time for a host-vehicle when the right-of-way rules are unable to determine when the host-vehicle should proceed into the intersection.

### BACKGROUND OF INVENTION

Fully automated or autonomous vehicles have been proposed where an operator of a host-vehicle is little more than a passenger of the vehicle, merely indicating a destination for the automated vehicle. However, situations may occur when normal right-of-way rules are unable to resolve a situation because, for example, multiple vehicles simultaneously arrive at an intersection.

### SUMMARY OF THE INVENTION

In accordance with one embodiment, a conflict-resolution system for operating an automated vehicle is provided. The system includes an intersection detector, a vehicle-detection device, and a controller. The intersection detector is suitable to mount on a host-vehicle. The detector used to determine when the host-vehicle is stopped at or approaches an intersection. The vehicle-detection device is suitable to mount on the host-vehicle. The device is used to detect when an other-vehicle has stopped at or is approaching the intersection at the same instant as the host-vehicle. The controller is in communication with the detector and the device. The controller is configured to determine a wait-time for the host-vehicle to wait before attempting to proceed into the intersection when right-of-way rules are unable to determine when the host-vehicle should proceed into the intersection.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a conflict-resolution system for operating an automated vehicle in accordance with one embodiment; and

FIG. 2 is traffic scenario that is processed by the system of FIG. 1 in accordance with one embodiment.

### DETAILED DESCRIPTION

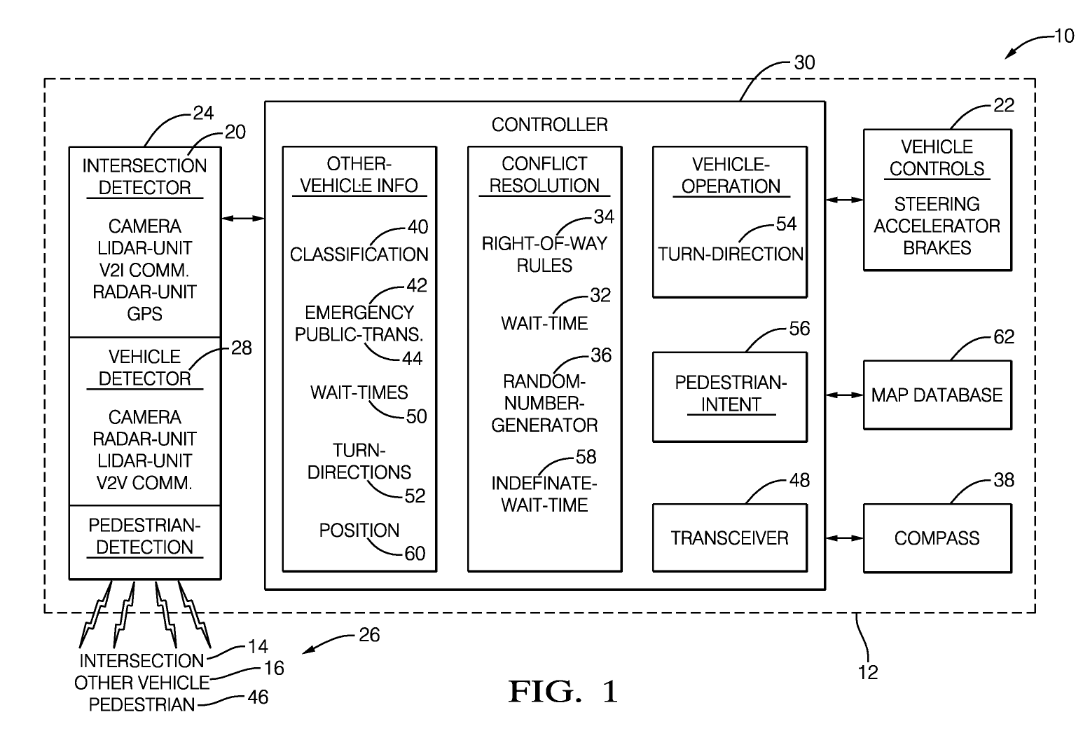

FIG. 1 illustrates a non-limiting example of a conflict-resolution system 10, hereafter the system 10, for operating an automated vehicle, i.e. an autonomous vehicle, e.g. a host-vehicle 12. While the system 10 described herein is presented in the context of a fully automated or autonomous vehicle where occupants of the host-vehicle 12 are not manually operating the vehicle-controls 22 (e.g. steering-wheel, accelerator, brakes), it is contemplated that the conflict-resolution aspects of the system 10 could benefit partially automated vehicles where a person manually operates all or some of the vehicle-controls 22, and the system 10 may merely advise or assist the operator with resolving a conflict with an other-vehicle 16. It is also contemplated that teachings presented herein can also be applied to robotic or remote controlled vehicles used to deliver goods, or transport customers who do not determine or influence the destination of the host-vehicle 12. The system 10 described herein resolves situations when, for example, two or more vehicles traveling in different directions arrive at an intersection simultaneously, and the normal or common right-of-way rules are insufficient to determine which of vehicles should proceed into the intersection first.

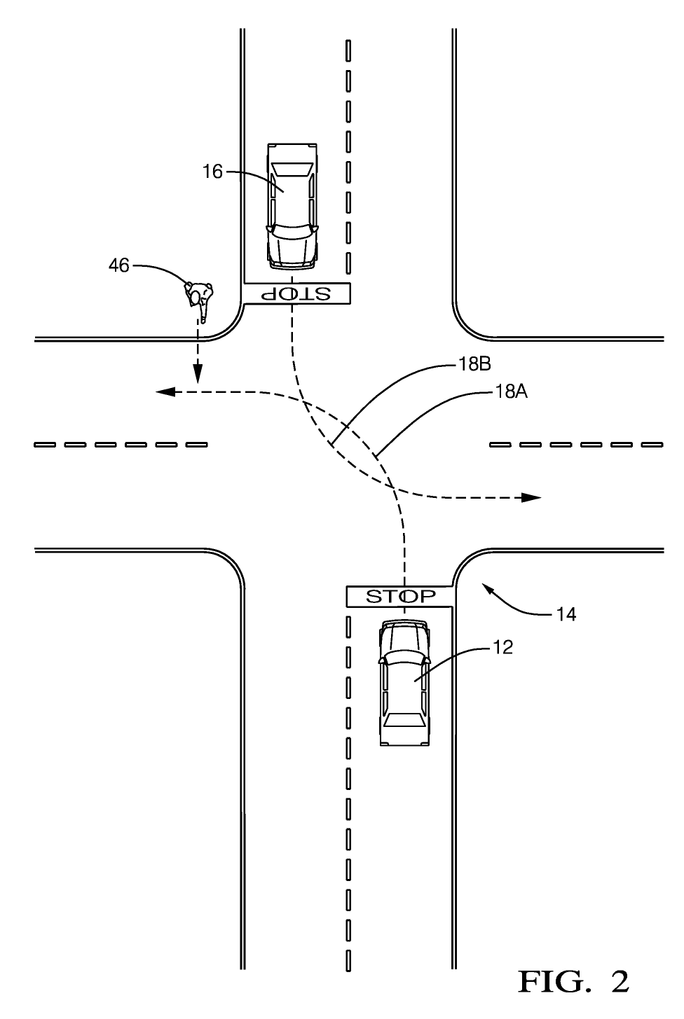

FIG. 2 illustrates a non-limiting example of an intersection 14 where the host-vehicle 12 and the other-vehicle 16 have arrived at the intersection 14 at essentially the same instant in time; both the host-vehicle 12 and the other-vehicle 16 intend to make left turns; and the travel-paths 18A, 18B of, respectively, the host-vehicle 12 and the other-vehicle 16 interfere with each other. That is, the configuration of the intersection 14 is such that the host-vehicle 12 and the other-vehicle 16 cannot proceed into the intersection 14 simultaneously without colliding with each other. While FIG. 2 shows a two-way stop where any cross-traffic (none shown) is not required to stop at the intersection 14, it is recognized that the teachings presented herein are applicable to other configuration of intersections such as an intersection characterized as a four-way stop, and that the teachings presented herein can be used to resolve conflicts when two or more vehicles arrive simultaneously at the four-way stop.

It is contemplated that the host-vehicle 12 may encounter instances of intersections where no signs are posted, two or more vehicles are approaching the un-marked intersection, and the normal or common right-of-way rules are insufficient to determine which of vehicles should proceed into the intersection first. The decision-logic directed to how the host should respond in this circumstance may not require the host-vehicle 12 to stop, but rather to slow-down and let the other-vehicle 16 precede unimpeded, and only stop if necessary.

Returning to FIG. 1, the system 10 includes external-sensors 24 operable to detect various landscape features or objects 26 proximate to the host-vehicle 12. For example, the external-sensors 24 may include an intersection detector 20, hereafter the detector 20, used to determine when the host-vehicle 12 is stopped at or approaches an intersection. The detector 20 may be one or more of a variety of sensors such as a camera or lidar-unit which is generally suitable to mount on the host-vehicle 12 for detecting when the host-vehicle 12 is at or approaching the intersection 14. Alternatively, the determination that the host-vehicle 12 is proximate to the intersection 14 may be by way of a global-positioning-system (GPS) and/or vehicle-to-infrastructure (V2I) communications that provide information about the configuration or layout of the intersection 14 by, for example, drawing information from a map database 62.

The system 10, or more specifically the external-sensors 24, generally includes a vehicle-detection device 28, hereafter the device 28, which is suitable to mount on the host-vehicle 12 and generally configured to detect the other-vehicle 16, and detect or determine when an other-vehicle 16 has stopped at or approaches the intersection 14 at the same instant as the host-vehicle 12. Specific devices that may be used to as the device 28 include, but are not limited to, a camera, a radar-unit, a lidar-unit, an ultrasonic-transducer, vehicle-to-infrastructure (V2I) communications, and/or vehicle-to-vehicle (V2V) communications. It is contemplated that some of the devices (e.g. the camera) may be used for both intersection-detection and vehicle-detection.

The system 10 also includes a controller 30 in communication with the detector 20 and the device 28. The controller 30 may include a processor (not specifically shown) such as a microprocessor or other control circuitry such as analog and/or digital control circuitry including an application specific integrated circuit (ASIC) for processing data as should be evident to those in the art. The controller 30 may include memory (not specifically shown), including non-volatile memory, such as electrically erasable programmable read-only memory (EEPROM) for storing one or more routines, thresholds, and captured data. The one or more routines may be executed by the processor to perform steps for determining when the host-vehicle 12 and the other-vehicle 16 stop at or approach the intersection 14 at essentially or approximately the same instant in time, within +/−1 second of each other for example, based on signals received by the controller 30 from the external-sensors 24.

In order to resolve the dilemma or conflict created when the host-vehicle 12 and the other-vehicle 16 stop at or approach the intersection 14 at essentially the same instant in time, the controller 30 is configured to determine a wait-time 32 for the host-vehicle 12 to wait before attempting to proceed into the intersection 14 when right-of-way rules 34 are unable to determine when the host-vehicle 12 should proceed into the intersection 14. That is, if the right-of-way rules 34 do not provide for a clear decision, then the problem is overcome by waiting for a period of time to see what the other-vehicle 16 does before the host-vehicle 12 attempts to enter the intersection. It is recognized that if both the host-vehicle 12 and the other-vehicle 16 are being operated in an autonomous mode and the versions of software in both vehicles are the same, at least with regard as to how to resolve the conflict described above, both vehicles may be waiting for an unacceptably long time before one of the vehicles attempts to enter the intersection 14. Accordingly, described herein are some alternative ways to select or determine the wait-time 32 which may help to more quickly resolve the conflict without having to engage persons residing/traveling in either of the vehicles.

In one embodiment the system 10 may include a random-number-generator 36 provided by either a separate hardware device or as a subroutine executed by the controller 30, as will be recognized by those in the art. Based on the value or number output by the random-number-generator 36, the wait-time 32 may be set to, for example, one of 0.5 seconds, 1.0 second, 1.5 seconds, or 2.0 seconds. If both the host-vehicle 12 and the other-vehicle 16 are equipped with systems that include random-number-generators, then it is more unlikely than likely that both vehicles will attempt to enter the intersection 14 at the same time. If both vehicle happen to select the same value for the wait-time 32 based on the output of the random-number-generator 36, then both vehicles may stop and select a new value for the wait-time 32 after both attempt to enter the intersection 14 at the same time. Eventually only one vehicle will begin to enter the intersection while the other waits for the wait-time 32 to expire. It is also contemplated that if one vehicle starts into the intersection 14 prior to the other, the other will enter the intersection as soon as the first clears. That is, for example, if the wait-time 32 of the host-vehicle 12 has not expired, but the other-vehicle 16 did not wait and entered the intersection 14 soon after stopping, the host-vehicle 12 can enter the intersection as soon as the other-vehicle 16 is clear. In summary, the controller 30 in this non-limiting embodiment is configured to determine the wait-time 32 based on a number output by the random-number-generator 36.

Alternatively, the system includes a compass 38, and the controller 30 may be configured to determine the wait-time 32 based on a heading of the host-vehicle 12 indicated by the compass 38. It is appreciated that this would need to be a convention subscribed to by the other-vehicle 16. For example, if the wait-time is set equal to the bearing in degrees divided by ten, then the wait-time 32 is 0.9 seconds when east-bound, 2.7 seconds when west-bound, and 0 (zero) or 3.6 seconds when north-bound depending on which side of true north the compass 38 indicates.

In another embodiment, the vehicle-detection device 28 is configured or used by the controller 30 to determine a classification 40 of the other-vehicle 16, and the wait-time 32 is set to indefinite 58, i.e. wait for the other-vehicle to go first, if the classification is one of an emergency-vehicle 42 (e.g. police-vehicle, fire-truck, ambulance, especially if emergency light are activated) and a public-transportation-vehicle 44 such as a trolley or bus. Alternatively, or in addition, the wait-time 32 may be set to indefinite 58 if the other-vehicle is being operated manually, e.g. is not automated.

In another embodiment, the external-sensors 24, for example the vehicle-detection device 28, may be configured to detect a pedestrian 46 proximate to the intersection 14, and the wait-time 32 is set to indefinite 58, i.e. wait for the pedestrian 46 to go first, if the pedestrian 46 is attempting to enter the intersection 14. The controller 30 may be equipped with a pedestrian-intent algorithm 56 that uses, for example, image processing of an image from the camera to determine which way the pedestrian 46 is facing, and if the pedestrian is moving in a direction that will intersect with the travel-path 18A of the host-vehicle 12. Alternatively, if the pedestrian 46 is moving in a direction that intersects only the travel-path 18B of the other-vehicle 16, the host-vehicle 12 may elect to proceed into the intersection 14 without waiting because the other-vehicle will be waiting for the pedestrian 46 to clear the intersection 14. Similarly, if a third vehicle is already in the intersection and moving in a direction that intersects only the travel-path 18B of the other-vehicle 16, the host-vehicle 12 may elect to proceed into the intersection 14 without waiting because the other-vehicle 16 will be waiting for the third vehicle to clear the intersection 14.

In another embodiment, the system 10 may include a transceiver 48 used to communicate (i.e. receive) information about other-vehicle(s) (the other-vehicle 16 and any other-vehicles not shown) proximate to the intersection 14, and the controller 30 is further configured to determine the wait-time 32 based on the information. The transceiver 48 may be part of the above mentioned V2V, V2I and/or a V2E (vehicle-to-everything) communication system. By way of example and not limitation, the information may include wait-times 50 of the other-vehicles (e.g. the other-vehicle 16) and/or a position 60 of each of the other-vehicles. The controller 30 may then indicates that the host-vehicle 12 should proceed into the intersection 14 immediately when the wait-time 32 of the host-vehicle 12 is less than the wait-times 50 of all of the other-vehicles that are waiting because of a conflict caused by simultaneous arrival times or other unspecified causes.

Alternatively, the information communicated via the transceiver 48 may include turn-directions 52 of the other-vehicles or the position 60 of each of the other-vehicles. It follows that the controller 30 may indicate that the host-vehicle 12 should proceed into the intersection 14 when a turn-direction 54 of the host-vehicle 12 is such that doing so will not interfere with the other-vehicles. It is also contemplated that the transceiver 48 could be used for communication with multiple vehicles to allow several-vehicles to proceed through the intersection 14 when traffic is very heavy and thereby eliminate congestion.

Alternatively, the information may include the classification 40 of the other-vehicle 16, and the wait-time 32 may be set to indefinite 58, i.e. wait for the other-vehicle 16 to go first, if the classification 40 is emergency-vehicle 42 or public-transportation-vehicle 44.

Accordingly, a conflict-resolution system (the system 10) for operating an automated vehicle (the host-vehicle 12), a controller 30 for the system 10, and a method of operating the system 10 is provided. A variety of schemes are proposed to resolve a potential conflict or dilemma arising from multiple vehicles arriving at an intersection at the same instant in time, which are typically not resolvable using the right-of-way rules conventionally used by humans to resolve conflicts.

While this invention has been described in terms of the preferred embodiments thereof, it is not intended to be so limited, but rather only to the extent set forth in the claims that follow.

1. A conflict-resolution system for operating an automated vehicle, said system comprising:
an intersection detector suitable to mount on a host-vehicle, said detector used to determine when the host-vehicle is stopped at an intersection;
a vehicle-detection device suitable to mount on the host-vehicle, said device used to detect when an other-vehicle has stopped at the intersection at the same instant as the host-vehicle; and
a controller in communication with the detector and the device, said controller configured to determine a wait-time for the host-vehicle to wait before attempting to proceed into the intersection when the host-vehicle and the other-vehicle have stopped at the intersection as the same instant, and right-of-way rules do not indicate which of the host-vehicle and the other-vehicle is authorized to enter the intersection first.

2. The system in accordance with claim 1, wherein the system includes a random-number-generator, and the controller is configured to determine the wait-time based on a number output by the random-number-generator.

3. The system in accordance with claim 1, wherein the system includes a compass, and the controller is configured to determine the wait-time based on a heading of the host-vehicle indicated by the compass.

4. The system in accordance with claim 1, wherein the vehicle-detection device is configured to determine a classification of the other-vehicle, and the wait-time is set to indefinite if the classification is one of an emergency-vehicle and a public-transportation-vehicle.

5. The system in accordance with claim 1, wherein the vehicle-detection device is configured to detect a pedestrian proximate to the intersection, and the wait-time is set to indefinite if the pedestrian is attempting to enter the intersection.

6. The system in accordance with claim 1, wherein the system includes a transceiver used to communicate information about other-vehicles proximate to the intersection, and the controller is configured to determine the wait-time based on the information.

7. The system in accordance with claim 6, wherein the information includes wait-times of the other-vehicles, and the controller indicates that the host-vehicle should proceed into the intersection when the wait-time of the host-vehicle is less than the wait-times of the other-vehicles.

8. The system in accordance with claim 6, wherein the information includes turn-directions of the other-vehicles, and the controller indicates that the host-vehicle should proceed into the intersection when a turn-direction of the host-vehicle is such that doing so will not interfere with the other-vehicles.

9. The system in accordance with claim 6, wherein the information includes a classification of the other-vehicle, and the wait-time is set to indefinite if the classification is one of an emergency-vehicle and a public-transportation-vehicle.

10. A conflict-resolution system for operating an automated vehicle, said system comprising:
an intersection detector suitable to mount on a host-vehicle, said detector used to determine when the host-vehicle approaches an intersection;
a vehicle-detection device suitable to mount on the host-vehicle, said device used to detect when an other-vehicle approaches the intersection at the same instant as the host-vehicle; and
a controller in communication with the detector and the device, said controller configured to determine a wait-time for the host-vehicle to wait before attempting to proceed into the intersection when the host-vehicle and the other-vehicle have stopped at the intersection as the same instant, and right-of-way rules do not indicate which of the host-vehicle and the other-vehicle is authorized to enter the intersection first.
